(19) United States
(12) Patent Application Publication
(10) Pub. No.: US 2006/0203165 A1
(43) Pub. Date: Sep. 14, 2006

(54) Display apparatus and viewing angle controlling unit

(76) Inventor: Minoru Shibazaki, Nishi-ku (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/568,558

(22) PCT Filed: Aug. 13, 2004
(86) PCT No.: PCT/IB04/51455

§ 371 Date: Feb. 17, 2006

(30) Foreign Application Priority Data
Aug. 22, 2003 (IB) 03/03800

(51) Int. Cl. G02F 1/1337

(52) U.S. Cl. 349/126

(57) ABSTRACT

In the case that a voltage is not applied to a viewing angle controlling unit (11), a polarized plate (113) passes only the light vibrating in an arrow direction of the light entered into the viewing angle controlling unit (11). The light passed the polarized plate (113) passes through a liquid crystal layer (120) without twisting. The light passed the liquid crystal layer (120) also passes through a polarized plate (111). Therefore, the display becomes transparent (white) in any viewing angle (in all direction) in viewing angle non-controlling mode. In the case that a voltage is applied to a viewing angle controlling unit (11) by a first power source (13), a polarized plate (113) passes only the light vibrating in an arrow direction of the light entered into the viewing angle controlling unit (11). The light passed the polarized plate (113) passes through a liquid crystal layer (120) along liquid crystal molecules. The light passed the liquid crystal layer (120) also passes through a polarized plate (111). Therefore, the display becomes transparent in the center of the viewing angle controlling unit (11). The display becomes black in the side region of the viewing angle controlling unit (11) because of having a predetermined angle between an optical axis of the polarized plate (111) and an axis direction of the liquid crystal molecules. In viewing angle controlling mode, the display is visible when viewed from the front, while the display is invisible when viewed in a slanting direction.

### TECHNICAL FIELD

The present invention relates to a display apparatus, in particular to a display apparatus with a viewing angle controlling unit.

### BACKGROUND ART

A display device, particularly, liquid crystal display device is required to have a wide viewing angle to enable the display to be viewed from not only the front of the display panel but also angles shifted from the front. Accordingly, in liquid crystal display devices, panels have been developed that have wide viewing angle characteristics.

Meanwhile, occasions have increased that data communications are performed using a cellular telephone and/or PDA (Portable Digital Assistance), and corresponding to such occasions, a case is increased that a user does not want people around the user to see the displayed data. Therefore, a liquid crystal display device used in such an application is required to have a function of enabling only the user to see the display while enabling people around the user not to see the display.

However, conventional liquid crystal display devices are not able to change an effective display viewing angle range in which the display is visible, and thus, cannot cope with cases that information is displayed which is desired to be invisible to people around the user.

### DISCLOSURE OF INVENTION

It is an object of the present invention to provide a display apparatus that is able to make visible or make invisible in particular direction. It is another object of the present invention to provide a viewing angle controlling unit which exhibits the function.

A display apparatus of the present invention is a display apparatus which includes a display device for displaying an image or a picture and a viewing angle controlling unit arranged over the display device, where the viewing angle controlling unit has a pair of substrates each of which has at least an electrode and an alignment film and which faces each other such that alignment films are opposite to each other, a liquid crystal layer sandwiched between the pair of substrates, and a pair of polarized plates arranged outside the pair of substrates sandwiching the liquid crystal layer, and rubbing directions of the respective alignment films in the pair of substrates are substantially parallel to each other.

In the display apparatus of the present invention, the pair of polarized plates are preferably arranged in crossed Nicols way or parallel Nicols way. In the case where the pair of polarized plates are arranged in crossed Nicols way, it is preferable that an optical axis of one polarized plate is at substantially right angle to the rubbing direction and that an optical axis of the other polarized plate is substantially parallel to the rubbing direction. In the case where the pair of polarized plates are arranged in parallel Nicols way, it is preferable that optical axes of the pair of polarized plates are substantially parallel to the rubbing direction.

The display apparatus of the present invention preferably has a power source for applying a voltage to the electrode, and further includes power source controlling means for controlling switching of the power source.

In the display apparatus of the present invention, a retardation value of the liquid crystal layer is preferably within a range of 200 nm to 1000 nm.

In the display apparatus of the present invention, the optical axis is preferably an absorption axis or a polarization axis.

In the display apparatus of the present invention, the display device is preferably a light-emitting type display device or light-receiving type display device. In the case where the display device is the light-emitting type display device, the viewing angle controlling unit is preferably arranged on a screen of the display device. It is preferable that the display device is a device selected from the group consisting of a liquid crystal display device, an electro-luminescence display device, a plasma display device and cathode ray tube.

### DESCRIPTION OF DRAWINGS

FIG. 1 is a view diagrammatically showing a part of a display apparatus according to the present invention;

FIG. 2 is a view showing a viewing angle controlling unit of a display apparatus according to an Embodiment 1 of the present invention;

FIG. 3 is a view showing a gray-scale characteristic of a display apparatus according to an Embodiment 1 of the present invention;

FIG. 4 is a view showing a viewing angle controlling unit of a display apparatus according to an Embodiment 2 of the present invention; and

FIG. 5 is a view showing a gray-scale characteristic of a display apparatus according to an Embodiment 2 of the present invention.

### BEST MODE

Embodiments of the present invention will be specifically described below with reference to accompanying drawings.

### Embodiment 1

This Embodiment describes a case where a viewing angle controlling unit makes the display visible when viewed from directions except the direction of the panel front.

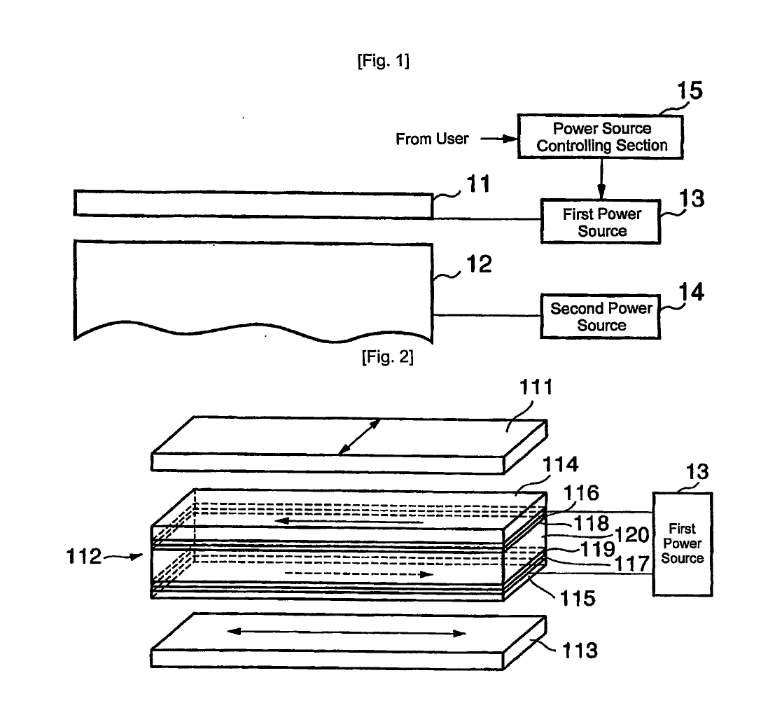

FIG. 1 is a view diagrammatically showing a part of a display apparatus according to the present invention. The display apparatus according to the present invention has a configuration such that a viewing angle controlling unit 11 is arranged over a display device 12 for driving.

Used as the display device 12 for driving are any display devices of light-emitting type or light-receiving type. For example, as the display device 12 for driving, there may be a liquid crystal display device (LCD), electro-luminescence (EL) display device, plasma display device (PDP) and cathode ray tube (CRT). In the case where the display device 12 for driving is the light-emitting type display device such as EL, PDP and CRT, as shown in FIG. 1, the viewing angle controlling unit 11 is arranged on a screen of the display device 12 for driving. When the display device 12 for driving is a liquid crystal display device, the viewing angle controlling unit 11 may be arranged on a screen of the display device 12 for driving or under the display device 12 for driving.

The viewing angle controlling unit 11 is connected to a first power source 13, while the display device 12 for driving is connected to a second power source 14. A power source controlling section 15 is connected to the first power source 13, and switches modes of the viewing angle controlling unit 11 by an instruction of a user or automatically.

FIG. 2 is a view showing the viewing angle controlling unit of the display apparatus according to Embodiment 1 of the present invention.

The viewing angle controlling unit 11 is mainly comprised of a pair of polarized plates 111 and 113, and a liquid crystal panel 112 sandwiched between the pair of polarized plates 111 and 113. The liquid crystal panel 112 is mainly comprised of a pair of substrates 114 and 115, electrodes 116 and 117 respectively provided on the substrates 114 and 115, alignment films 118 and 119 respectively provided on the electrodes 116 and 117, and a liquid crystal layer 120 sandwiched between the substrates 114 and 115. In addition, optical elements such as a color filter and retardation film are practically provided, but are omitted herein for sake of simplicity.

The polarized plates 111 and 113 are arranged so that their optical axes (absorption axis or polarization axis) are substantially perpendicular to each other (crossed Nicols). Accordingly, respective absorption axes or polarized axes of the polarized plates 111 and 113 are set to be substantially perpendicular to each other.

Examples used as the substrates 114 and 115 are a glass substrate, transparent plastic substrate and transparent film.

Examples used as the electrodes 116 and 117 are a transparent electrode such as ITO and a metal electrode. The electrodes 116 and 117 are connected to the first power source 13.

As the alignment films 118 and 119, there may be a polymer film such as a polyimide film and an inorganic material layer such as an SiO₂ layer. In the case where a polymer film is used as the alignment film, rubbing processing is performed on the formed polymer film. In the case where an inorganic material layer is used as the alignment film, the layer is formed by depositing the organic material in oblique evaporation. This Embodiment describes the case of using a polymer film as the alignment film.

The directions of rubbing processing on the alignment films 118 and 119 are at substantially right angle to the optical axis of the polarized plate 111, while being substantially parallel to the optical axis of the polarized plate 113 (directions of arrows in the liquid crystal panel in the figure). Thus, the rubbing directions of the alignment films 118 and 119 are substantially parallel to each other, and the twisted angle of liquid crystal molecules is approximately 0°.

In the liquid crystal layer 120, by adjusting the retardation, it is possible to control the direction in which the display is visible. Increasing the retardation value enables the display to be viewed from positions forming large angles with respect to the panel front (0°), while decreasing the retardation value enables the display to be viewed from positions forming small angles with respect to the panel front (0°). For example, in order to enable the display to be viewed in a range such that angles from the panel front (0°) range from about 5° to 60°, the retardation value is set in a range of 200 nm to 1000 nm.

The operation of the viewing angle controlling unit 11 with the aforementioned configuration will be described below.

A state (viewing angle non-controlling mode) will be described first where the first power source 13 does not apply the voltage to the viewing angle controlling unit 11. In the viewing angle non-controlling mode, the power source controlling section 15 instructs the first power source 13 not to apply the voltage (or, no instruction on application of voltage).

By the rubbing processing performed on the alignment films 118 and 119, the liquid crystal molecules inside the liquid crystal layer 120 of the liquid crystal panel 112 are aligned so that the longitudinal direction is along the rubbing direction. When the voltage is not applied to the viewing angle controlling unit 11, the liquid crystal molecules remain the state where the longitudinal direction is along the rubbing direction. Further, as described above, the polarized plates 111 and 113 are arranged so that respective optical axes are substantially perpendicular to each other.

Accordingly, with respect to light incident on the viewing angle controlling unit 11 (light incident on the polarized plate 111 from a lower position viewed in the figure), light vibrating only in the direction of the arrow of the polarized plate 113 is passed through the plate 113. As described above, the rubbing directions of the rubbing processing performed on the alignment films 118 and 119 are substantially parallel to each other, and the twisted angle is substantially 0°. Therefore, the light passed through the polarized plate 113 is passed through the liquid crystal layer 120 in the same state without twisting.

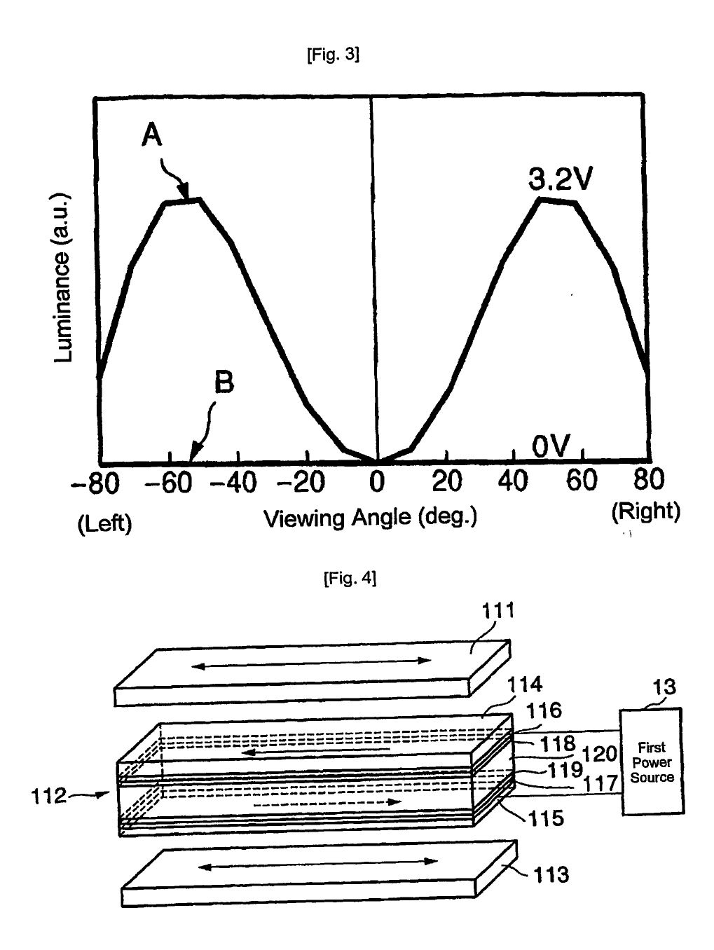

Meanwhile, since the optical axis of the polarized plate 111 is substantially perpendicular to the optical axis of the polarized plate 113, the light passed through the liquid crystal layer 120 is not allowed to pass through the polarized plate 111. Therefore, as shown in FIG. 1, when the viewing angle controlling unit 11 is arranged over the display device 12 for driving, the display is black in any viewing angles (in all the directions) in the viewing angle non-controlling mode (characteristic line B in FIG. 3).

Next, a state (viewing angle controlling mode) will be described where the first power source 13 applies the voltage to the viewing angle controlling unit 11. In the viewing angle controlling mode, the power source controlling section 15 instructs the first power source 13 to apply the voltage (herein, 3.2V).

When the first power source 13 applies the voltage to the viewing angle controlling unit 11, the liquid crystal molecules aligned by the alignment films 118 and 119 are aligned in the electric filed direction (the longitudinal direction of the liquid crystal molecule is aligned in the width direction of the liquid crystal layer 120).

Accordingly, with respect to light incident on the viewing angle controlling unit 11 (light incident on the polarized plate 111 from a lower position viewed in the figure), light vibrating only in the direction of the arrow of the polarized plate 113 is passed through the plate 113. As described above, the liquid crystal molecules in the liquid crystal layer 120 are aligned so that the longitudinal direction is along the width direction of the liquid crystal layer 120, and thus in a state of standing. Therefore, the light passed through the polarized plate 113 is passed through the liquid crystal layer 120 along the liquid crystal molecules.

Meanwhile, since the optical axis of the polarized plate 111 is substantially perpendicular to the optical axis of the polarized plate 113, the light passed through the liquid crystal layer 120 is not allowed to pass through the polarized plate 111. Therefore, the display is black in the center of the viewing angle controlling unit 11 (i.e. when the display panel is viewed from the front).

However, in a side region of the viewing angle controlling unit 11 (i.e. when the display panel is viewed in a slanting direction forming a predetermined angle with the front), since a predetermined angle is formed between the optical axis of the polarized plate 111 and the axis direction (longitudinal direction) of the liquid crystal molecule, the display is transparent (white). Accordingly, as shown in FIG. 1, in the case where the viewing angle controlling unit 11 is arranged over the display device 12 for driving in the viewing angle controlling mode, the display is invisible when the display panel is viewed from the front, while being visible when the display panel is viewed in the slanting directions (characteristic line A in FIG. 3).

According to the display apparatus of this Embodiment, it is possible to make the display visible or invisible in only a particular direction by user's or automatic mode switching. It is thus possible to use the apparatus effectively when a person whom the display is desired to be invisible is present at the front of the display panel. For example, by applying the display apparatus according to this Embodiment to a monitor for vehicles and setting the viewing angle controlling mode, it is possible to make a display screen invisible to a driver, while making the display screen visible to a person at the passenger side.

### Embodiment 2

This Embodiment describes a case where a viewing angle controlling unit makes the display visible when viewed from the panel front.

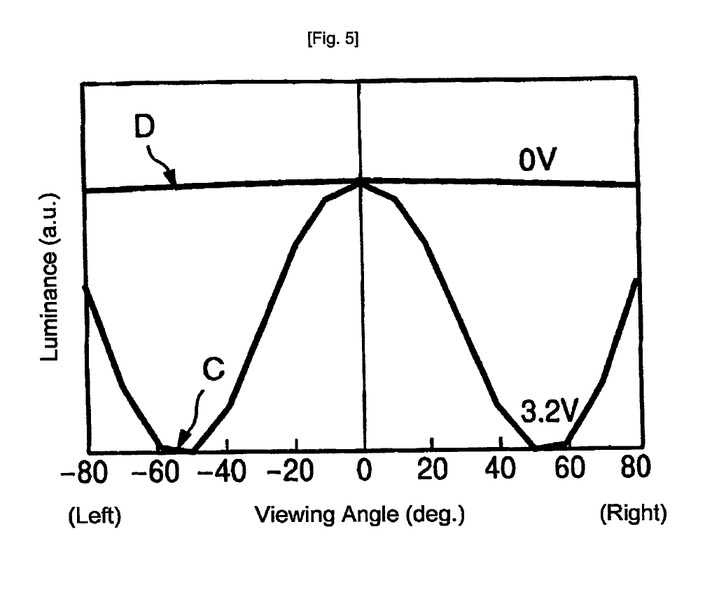

FIG. 4 is a view showing the viewing angle controlling unit of a display apparatus according to Embodiment 2 of the present invention.

The viewing angle controlling unit 11 is mainly comprised of a pair of polarized plates 111 and 113, and a liquid crystal panel 112 sandwiched between the pair of polarized plates 111 and 113. The liquid crystal panel 112 is mainly comprised of a pair of substrates 114 and 115, electrodes 116 and 117 respectively provided on the substrates 114 and 115, alignment films 118 and 119 respectively provided on the electrodes 116 and 117, and a liquid crystal layer 120 sandwiched between the substrates 114 and 115. In addition, optical elements such as a color filter and retardation film are practically provided, but are omitted herein for sake of simplicity.

The polarized plates 111 and 113 are arranged so that their optical axes (absorption axis or polarization axis) are substantially parallel to each other (parallel Nicols). Accordingly, respective absorption axes or polarized axes of the polarized plates 111 and 113 are set to be substantially parallel to each other.

The same materials as those in Embodiment 1 may be used, as materials of the substrates 114 and 115, the electrodes 116 and 117 and the alignment films 118 and 119. The electrodes 116 and 117 are connected to the first power source 13.

The directions of rubbing processing on the alignment films 118 and 119 are substantially parallel to the optical axis of the polarized plate 111, and further substantially parallel to the optical axis of the polarized plate 113 (directions of arrows in the liquid crystal panel in the figure). Thus, the rubbing directions of the alignment films 118 and 119 are substantially parallel to each other, and the twisted angle of liquid crystal molecules is approximately 0°.

In the liquid crystal layer 120, by adjusting the retardation, it is possible to control the direction in which the display is visible. Increasing the retardation value enables the display to be viewed from positions forming large angles with respect to the panel front (0°), while decreasing the retardation value enables the display to be viewed from positions forming small angles with respect to the panel front (0°). For example, in order to enable the display to be viewed in a range such that angles from the panel front (0°) range from about 5° to 60°, the retardation value is set in a range of 200 nm to 1000 nm.

The operation of the viewing angle controlling unit 11 with the aforementioned configuration will be described below.

A state (viewing angle non-controlling mode) will be described first where the first power source 13 does not apply the voltage to the viewing angle controlling unit 11. In the viewing angle non-controlling mode, the power source controlling section 15 instructs the first power source 13 not to apply the voltage (or, no instruction on application of voltage).

By the rubbing processing performed on the alignment films 118 and 119, the liquid crystal molecules inside the liquid crystal layer 120 of the liquid crystal panel 112 are aligned so that the longitudinal direction is along the rubbing direction. When the voltage is not applied to the viewing angle controlling unit 11, the liquid crystal molecules remain the state where the longitudinal direction is along the rubbing direction. Further, as described above, the polarized plates 111 and 113 are arranged so that respective optical axes are substantially parallel to each other.

Accordingly, with respect to light incident on the viewing angle controlling unit 11 (light incident on the polarized plate 111 from a lower position viewed in the figure), light vibrating only in the direction of the arrow of the polarized plate 113 is passed through the plate 113. As described above, the rubbing directions of the rubbing processing performed on the alignment films 118 and 119 are substantially parallel to each other, and the twisted angle is substantially 0°. Therefore, the light passed through the polarized plate 113 is passed through the liquid crystal layer 120 in the same state without twisting.

Meanwhile, since the optical axis of the polarized plate 111 is substantially parallel to the optical axis of the polarized plate 113, the light passed through the liquid crystal layer 120 is allowed to pass through the polarized plate 111. Therefore, as shown in FIG. 1, when the viewing angle controlling unit 11 is arranged over the display device 12 for driving, the display is transparent (white) in any viewing angles (in all the directions) in the viewing angle non-controlling mode (characteristic line D in FIG. 5).

Next, a state (viewing angle controlling mode) will be described where the first power source 13 applies the voltage to the viewing angle controlling unit 11. In the viewing angle controlling mode, the power source controlling section 15 instructs the first power source 13 to apply the voltage (herein, 3.2V).

When the first power source 13 applies the voltage to the viewing angle controlling unit 11, the liquid crystal molecules aligned by the alignment films 18 and 119 are aligned in the electric filed direction (the longitudinal direction of the liquid crystal molecule is aligned in the width direction of the liquid crystal layer 120).

Accordingly, with respect to light incident on the viewing angle controlling unit 11 (light incident on the polarized plate 111 from a lower position viewed in the figure), light vibrating only in the direction of the arrow of the polarized plate 113 is passed through the plate 113. As described above, the liquid crystal molecules in the liquid crystal layer 120 are aligned so that the longitudinal direction is along the width direction of the liquid crystal layer 120, and thus in a state of standing. Therefore, the light passed through the polarized plate 113 is passed through the liquid crystal layer 120 along the liquid crystal molecules.

Meanwhile, since the optical axis of the polarized plate 111 is substantially parallel to the optical axis of the polarized plate 113, the light passed through the liquid crystal layer 120 is also allowed to pass through the polarized plate 111. Therefore, the display is transparent in the center of the viewing angle controlling unit 11 (i.e., when the display panel is viewed from the front).

However, in a side region of the viewing angle controlling unit 11 (i.e. when the display panel is viewed in a slanting direction forming a predetermined angle with the front), since a predetermined angle is formed between the optical axis of the polarized plate 111 and the axis direction (longitudinal direction) of the liquid crystal molecule, the display is black. Accordingly, as shown in FIG. 1, in the case where the viewing angle controlling unit 11 is arranged over the display device 12 for driving in the viewing angle controlling mode, the display is visible when the display panel is viewed from the front, while being invisible when the display panel is viewed in the slanting directions (characteristic line C in FIG. 5).

According to the display apparatus of this Embodiment, it is possible to make the display visible or invisible in only a particular direction by user's or automatic mode switching. It is thus possible to use the apparatus effectively when a person whom the user does not want to see tile display is present at opposite ends of the display panel (positions forming predetermined angles from the front). For example, with the display apparatus according to this Embodiment applied to a PDA, the viewing angle controlling mode is set when personal information is displayed, while the viewing angle non-controlling mode is set when a picture and/or image is shown to another person.

The viewing angle controlling unit can be made in thickness on the order of several micrometers by forming each structural element in the shape of a film. Therefore, the entire viewing angle controlling unit can be formed in the shape of a sheet, and is thus capable of being arranged on the display screen with simplicity without increasing the thickness of the display device.

The present invention is not limited to aforementioned Embodiments 1 and 2, and is capable of being carried into practice with various modifications thereof. For example, the materials and numerals as described in the above-mentioned Embodiments 1 and 2 are illustrative, not restrictive, and capable of being modified in various manners as long as the same effects are exhibited.

### INDUSTRIAL APPLICABILITY

The present invention is effectively applicable to a display device of light-emitting type or light-receiving type such as an LCD, EL, PDP and CRT.

1. A display apparatus including a display device for displaying an image or a picture and a viewing angle controlling unit arranged over said display device, said viewing angle controlling unit comprising:
a pair of substrates, each comprising at least an electrode and an alignment film, facing each other such that said alignment films are opposite to each other;
a liquid crystal layer sandwiched between said pair of substrates; and
a pair of polarized plates arranged outside said pair of substrates sandwiching said liquid crystal layer;
wherein rubbing directions of the respective alignment films of said pair of substrates are substantially parallel to each other.

2. A display apparatus as claimed in claim 1, wherein said pair of polarized plates are arranged in crossed Nicols way.

3. A display apparatus as claimed in claim 2, wherein an optical axis of one polarized plate is substantially perpendicular to said rubbing direction and an optical axis of an other polarized plate is in substantially parallel to said rubbing direction.

4. A display apparatus as claimed in claim 1, wherein said pair of polarized plates are arranged in parallel Nicols way.

5. A display apparatus as claimed in claim 4, wherein optical axes of said pair of polarized plates are in substantially parallel to said rubbing direction.

6. A display apparatus as claimed in claim 1, further comprising a power source for applying a voltage to said electrode and power source controlling means for controlling the switching of said power source.

7. A display apparatus as claimed in claim 1, wherein a retardation value of said liquid crystal layer is within the range of 200 nm to 1000 nm.

8. A display apparatus as claimed in claim 1, wherein said optical axis is an absorption axis or a transparent axis.

9. A display apparatus as claimed in claim 1, wherein said display device is a light-receiving type of display device or a light-emitting type of display device.

10. A display apparatus as claimed in claim 9, wherein in the case that said display device is the light-emitting type of display device, said viewing angle controlling unit is arranged on a display screen of said display device.

11. A display device as claimed in claim 9, wherein said display device is a device selected from a group consisting of a liquid crystal display device, an electro-luminescence display device, a plasma display device and a cathode ray tube.

12. A viewing angle controlling unit comprising:
a pair of substrates, each having at least an electrode and an alignment film, facing each other such that said alignment films are opposite to each other;
a liquid crystal layer sandwiched between said pair of substrates; and
a pair of polarized plates arranged outside said pair of substrates sandwiching said liquid crystal layer;
wherein rubbing directions of the respective alignment films of said pair of substrates are substantially parallel to each other.

13. A viewing angle controlling unit as claimed in claim 12, wherein said pair of polarized plates are arranged in crossed Nicols way.

14. A viewing angle controlling unit as claimed in claim 13, wherein an optical axis of one polarized plate is substantially perpendicular to said rubbing direction and an optical axis of an other polarized plate is in substantially parallel to said rubbing direction.

15. A viewing angle controlling unit as claimed in claim 12, wherein said pair of polarized plates are arranged in parallel Nicols way.

16. A viewing angle controlling unit as claimed in claim 15, wherein optical axes of said pair of polarized plates are in substantially parallel to said rubbing direction.

17. A viewing angle controlling unit as claimed in claim 12, further comprising a power source for applying a voltage to said electrode and power source controlling means for controlling the switching of said power source.

18. A viewing angle controlling unit as claimed in claim 12, wherein a retardation value of said liquid crystal layer is within the range of 200 nm to 1000 nm.

19. A viewing angle controlling unit as claimed in claim 12, wherein said optical axis is an absorption axis or a transparent axis.
